(19) United States
(12) Patent Application Publication
(10) Pub. No.: US 2026/0110839 A1
(43) Pub. Date: Apr. 23, 2026

(54) PHOTONIC INTEGRATED CIRCUIT FOR INDIVIDUAL ADDRESSING OF MULTI-ATOM ARRAYS

(71) Applicant: IonQ, Inc., College Park, MD (US)

(72) Inventors: Jeremy Matthew SAGE, Acton, MA (US); Kang TAN, College Park, MD (US); Juan Camilo BOHORQUEZ, Bothell, WA (US); Aytekin OZDEMIR, Tucson, AZ (US)

(21) Appl. No.: 19/360,794

(22) Filed: Oct. 16, 2025

Related U.S. Application Data
(60) Provisional application No. 63/708,545, filed on Oct. 17, 2024.

(51) Int. Cl. G02B 6/12; G02B 6/124

(52) U.S. Cl. CPC G02B 6/12019; G02B 6/12004; G02B 6/124; G02B 2006/12102; G02B 2006/12107; G02B 2006/12147

(57) ABSTRACT

Aspects of the present disclosure relate generally to a photonic integrated circuit for addressing a multi-point array including an array of grating couplers, and a chip-scale flat optical lens overlaying the array of grating couplers. A number of grating couplers in the array of grating couplers may be greater than or equal to a number of points of the multi-point array to be addressed and a lateral width of each grating coupler of the array of grating couplers may be less than or equal to a lateral interpoint spacing of the points to be addressed.

### CROSS REFERENCE TO RELATED APPLICATIONS

This application claims priority to U.S. Provisional Patent Application No. 63/708,545, filed Oct. 17, 2024, the entire contents of which are hereby incorporated by reference.

### TECHNICAL FIELD

Aspects of the present disclosure relate generally to systems and methods for producing light beams that address individual points of multi-point arrays. The systems and methods are particularly useful for individually addressing multiple ions of a multi-ion array in an ion trap to implement quantum computations.

### BACKGROUND

Trapped atoms are one of the leading implementations for quantum information processing or quantum computing. Other implementations include those based on superconducting qubits or photonic qubits, for example. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, and/or control of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of systems and methods for producing light beams that address individual points of multi-point arrays. The systems and methods are particularly useful for individually addressing multiple ions of a multi-ion array in an ion trap to implement quantum computations. Advantageously, aspects of the methods and systems of this disclosure facilitate miniaturization of components of ion trap quantum computers.

In one exemplary aspect, a photonic integrated circuit is provided for addressing a multi-point array. The photonic integrated circuit includes an array of grating couplers, and at least one chip-scale flat optical lens overlaying the array of grating couplers. Moreover, a number of grating couplers in the array of grating couplers is greater than or equal to a number of points of the multi-point array to be addressed.

In another exemplary aspect, a method is provided for controlling laser beam propagation in quantum processing. In this aspect, the method comprises providing a photonic integrated circuit for addressing a multi-point array comprising an array of grating couplers, and one or more chip-scale flat optical lenses overlaying the array of grating couplers; and transmitting light beams through the grating couplers of the array of grating couplers such that each point of the multipoint array is addressed by a single one of the light beams. Moreover, a number of grating couplers in the array of grating couplers is greater than or equal to a number of points of the multi-point array to be addressed, and a lateral width of each grating coupler of the array of grating couplers is less than a lateral interpoint spacing of the points to be addressed.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which.

FIG. 1 illustrates a view of atomic ions a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4A illustrates a side view of an example of a photonic integrated circuit of this disclosure.

FIG. 4B illustrates a plan view of an example of a photonic integrated circuit of this disclosure.

FIG. 5 illustrates a side view of another example of a photonic integrated circuit of this disclosure.

### DETAILED DESCRIPTION

The present disclosure recognizes and addresses the issue of miniaturization of optical components, particularly those of ion trap quantum computers. This disclosure describes various aspects of methods and systems that enable the production of wide elliptical light beams using compact optical components.

It would be advantageous to miniaturize the optical components of a system, such as a QIP system, into a compact form factor that is suitable to be rack mounted on a conventional server rack or server cabinet. Photonic integrated circuits (“PIC”) are suitable technology to miniaturize optical devices, scale up the component quantities, improve the robustness, and reduce the assembly cost and time for the optical systems. Integrated photonic solutions can be used to generate, amplify, shape, deliver, modulate, and detect light beams.

In some applications, such as a trapped-ion quantum computer, it is desired for a light beam to address individual ions or atoms for control, as well as to collect light emitted by ions or atoms for detection. This kind of control and detection is regularly required for quantum computing, quantum sensing, and quantum networking with ions and atoms, and PIC technology has the particular benefit of potentially enabling scalable, low-noise, low-cost, and compact optical systems as compared to those based on other optical technologies such as bulk and fiber optics.

One way in which, for example, individual trapped ions can be addressed with individual laser beams is through the use of PIC grating couplers, as was first demonstrated by Mehta, K., et al., (2016) “Integrated optical addressing of an ion qubit.” Nature Nanotechnology 11, 1066-1070. This approach, however, may not be suitable if the spacing between ions is small compared to the lateral extent of the grating couplers. This situation naturally arises with long chains of ions, such as chains greater than 2 to 5 ions, in which ions are spaced a few micrometers apart. To individually address an ion without appreciable optical cross-talk to the neighboring ion(s), the beam must be focused to a diameter which is less than the inter-ion spacing. However, due to the fundamental nature of light and numerical aperture, a focused beam diverges from the focal point at a rate which is inversely proportional to the beam diameter at the focus and proportional to the wavelength of light. With a grating coupler situated even just tens of microns away from the focal point (as would be the case if they are integrated into a chip-scale ion trap), this demands the grating coupler have a lateral extent of much greater than 3 micrometers. As a result, it is not possible to fit an array of grating couplers below the array of ions to deliver a beam per ion from each grating coupler. The gratings would overlap each other and would cease to function properly.

One potential solution is to position the gratings far enough apart from one another so as to not overlap, and then angle with an angle increasing with distance away from the center of the array. However, this solution would only be suitable for a short chain. For longer chains, the angle would be so extreme as to limit crosstalk suppression, as well as to have insufficient k-vector projection onto in-plane radial modes, which would preclude driving two-qubit entangling gates within the chain.

Accordingly, there remains a need for a miniaturized apparatus or system that can address a multi-point array. In contrast to conventional systems, this disclosure provides systems and apparatuses that consume a small amount of space yet are capable of producing light beams addressing individual points of multi-point arrays with minimal cross-talk over a short distance.

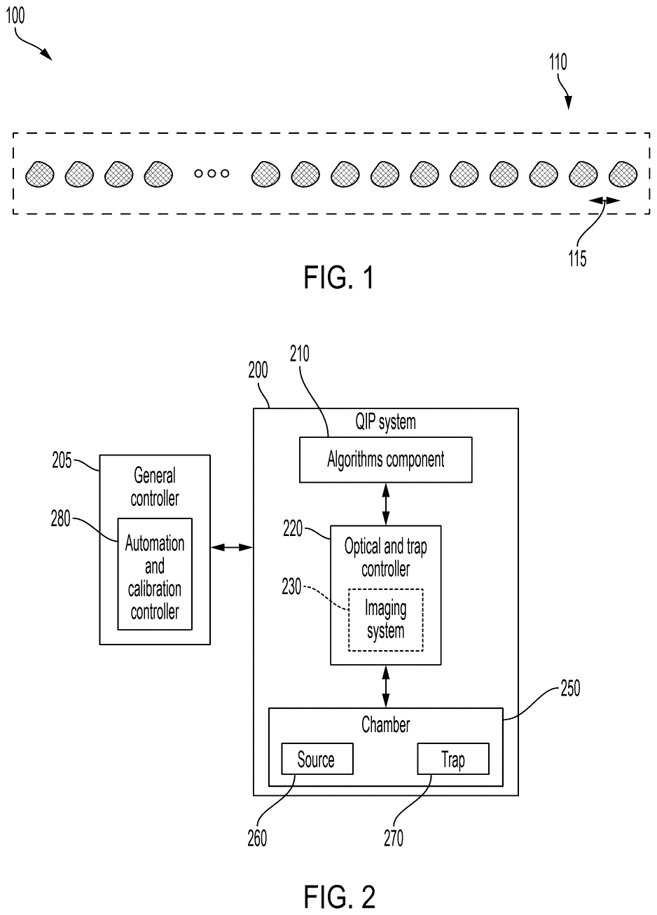

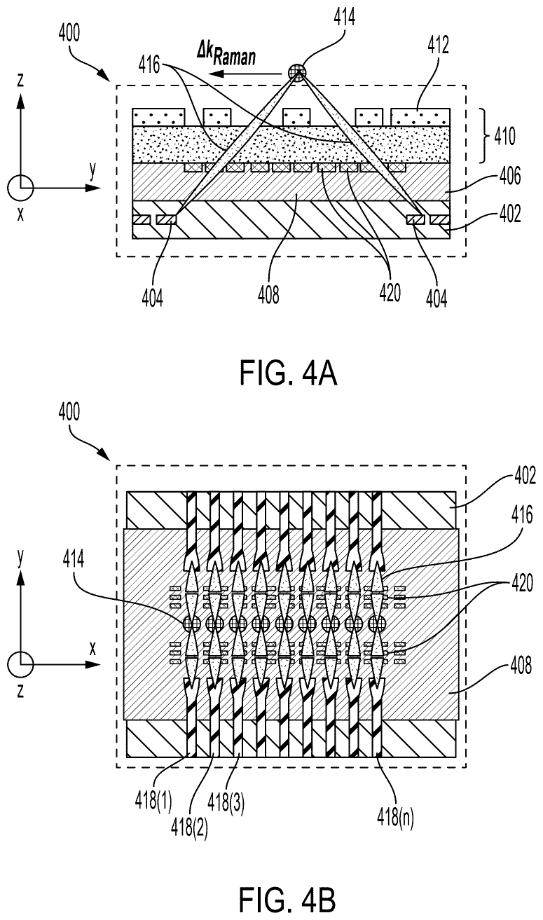

Solutions to the issues described above are explained in more detail in connection with FIGS. 4-6, with FIGS. 1-3 providing a background of QIP systems or quantum computers, and more specifically, of atomic-based QIP systems or quantum computers.

FIG. 1 shown below illustrates a diagram 100 with multiple atomic ions 106 (e.g., atomic ions 106a, 106b, . . . , 106c, and 106d) trapped in a linear crystal or chain 110 using a trap (the trap can be inside a vacuum chamber as shown in FIG. 2 or inside a plurality of nested vacuum chambers). The trap may be referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110. While some examples utilize atomic ions as atomic qubits as shown in FIG. 1, in some examples, each one of the atomic qubits can be a neutral atom.

In the example shown in FIG. 1, the trap includes electrodes for trapping or confining multiple atomic ions into the chain 110 that are laser-cooled to be nearly at rest. The number of atomic ions (N) trapped can be configurable and more or fewer atomic ions may be trapped. In some examples, the trap may trap 32, 64, 96, 128 or any other configuration or number of ions. In some examples, the trap may emit electrical fields (e.g., electromagnetic, electrostatic, etc.) in a predetermined configuration that organize a plurality of ions into one or more ion chains in a single ion trap.

Suitable atomic ions include but are not limited to Ytterbium ions (e.g., ^{171Yb+} ions) or Barium ions (e.g., ^{133Ba+} ions), for example. The atomic ions are illuminated with laser (optical) radiation tuned to a resonance corresponding to the desired atomic ion (e.g., ^{171Yb+}) and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and may or may not be uniform. Moreover, in addition to atomic Ytterbium ions, neutral atoms, Rydberg atoms, different atomic ions or different species of atomic ions may also be used. The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 shown below is a block diagram that illustrates an example of a QIP system 200 in accordance with various aspects of this disclosure. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations.

Shown in FIG. 2 is a general controller 205 configured to perform various control operations of the QIP system 200. Instructions for the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. As such, the algorithms component 210 may provide instructions to various components of the QIP system 200 (e.g., to the optical and trap controller 220) to enable the implementation of the quantum algorithms or quantum operations. The algorithms component 210 may receive information resulting from the implementation of the quantum algorithms or quantum operations and may process the information and/or transfer the information to another component of the QIP system 200 or to another device for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. The lasers and optical systems can be at least partially located in the optical and trap controller 220 and/or in the chamber 250 or otherwise positioned to allow the optical beams to interact with the ions in the trap. For example, optical systems within the chamber 250 may refer to optical components or optical assemblies. Additionally, in some examples, the chamber 250 may comprise a plurality of nested vacuum chambers, such as an interior vacuum chamber positioned inside of another vacuum chamber.

In other implementations, the QIP system 200 can include solid-state devices of one of several types. Such devices can be embodied in, for example, Josephson junction devices, semiconductor quantum-dots, defects in a semiconductor material (such as vacancies in Si and Ge, or nitrogen-vacancy centers in diamond or silicon carbide), or electron spin centers in semiconductors (doped or intrinsic). Superconducting qubits and spin qubits can be individually addressable by microwave electromagnetic radiation.

The QIP system 200 may include an imaging system 230. The imaging system 230 may include a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the imaging system 230 can be implemented separate from the optical and trap controller 220, however, the use of fluorescence to detect, identify, and label atomic ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the general controller 205, the automation and calibration controller 280, and/or the algorithms component 210.

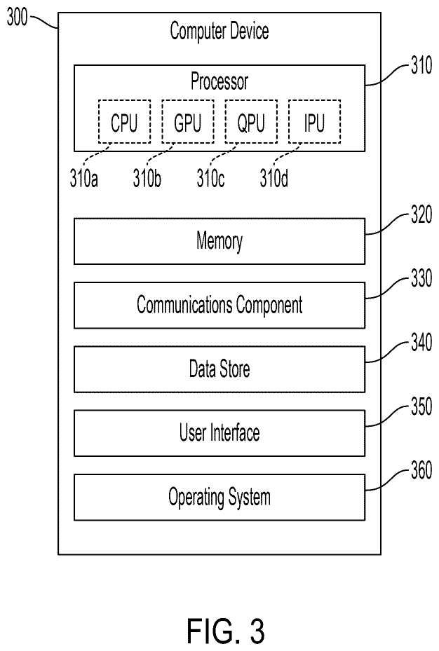

Referring now to FIG. 3 shown below, illustrated is an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, systems and techniques of this disclosure are described in more detail below.

Aspects of this disclosure relate to components of an optical and trap controller 220 that advantageously utilizes a photonic integrated circuit having an array of grating couplers that emit multiple light beams capable of individually addressing the points of a multipoint array, when coupled to a light source. In particular, one or more components of the optical and trap controller 220 may be configured using one or more photonic integrated circuits as disclosed herein.

Aspects of this disclosure relate to methods and systems that are scalable to long linear chains of closely spaced ions and which allows for beams with propagation k-vectors which do not change as a function of the position of the ion in the linear chain. The method and systems utilize an array of PIC grating couplers appropriate in number to the number of points (e.g., ions in an ion trap) to be addressed. In some examples, to facilitate miniaturization, the grating coupler may have a lateral extent smaller than the interpoint spacing such that the grating couplers do not overlap with one another. In an exemplary aspect, the gratings emit beams may diverge in space as they travel generally orthogonally from the surface of the chip on which they are positioned. A chip-scale flat optical lens (also referred to as a “flat lens”) or an optical relay composed of one or more such elements is further positioned in the path of light beams emitted from the grating array. The chip-scale flat optical lens advantageously may focus, or image, the light from the grating couplers onto the multipoint array.

In one example configuration, the flat lens can be designed to have a focal length approximately equal to a distance between the flat lens and the ion array and the flat lens can also be positioned to be approximately a focal length away from the grating array. In this configuration, the magnification of the lens will be one, and the beam size at each ion will be equal to the beam size at the grating emission point.

In other examples, the flat lens may be configured with different focal lengths and/or at different locations relative to the ion and grating arrays, to achieve different magnifications as desired. Additionally, in some examples the flat lens may be configured to also change the mode of each beam from, e.g., Gaussian as emitted by the grating to, e.g., a flat top beam in order to, e.g., further reduce cross-talk. Other mode conversion options are clearly also possible as desired.

In some aspects of this disclosure, a chip-scale flat optical lens may be configured as an element of an optical relay comprising at least two chip-scale flat optical lenses. Advantageously, to improve the light collection efficiency from the grating couplers, the chip-scale flat optical lens may be configured as a double telecentric 4f relay system. A symmetrical 4f, double telecentric relay telescope with magnification of 1× offers several advantages when addressing multiple beams to an ion chain with a required beam waist. The symmetrical 4f design helps to cancel out aberrations, ensuring a high-quality beam profile. In addition, the telecentric and symmetrical design makes the system less sensitive to misalignments and environmental changes. Furthermore, this 4f design with minimum two flat optics (e.g., metalenses) can be extended to accommodate multiple ion chains or scaled up for larger systems.

Aspects of this disclosure relate to methods and systems that can also be used to collect light from the ion array into the grating couplers and PIC waveguides, essentially enabling individual ion detection with low crosstalk by operating the concept “in reverse”.

FIGS. 4A and 4B depict an example of a photonic integrated circuit 401. The photonic integrated circuit 401 may be formed using any suitable technique, such as but not limited to silicon-on-insulator, silica-on-silicon and the like. In some examples, the photonic integrated circuit 401 may include Si, Si₃N₄, SiON, InP (Indium Phosphide), GaInAs (Indium gallium arsenide), GaInAsP (Gallium Indium Arsenide Phosphide) or other suitable materials.

As shown in FIGS. 4A and 4B, a photonic integrated circuit 400 for addressing a multi-point array. FIG. 4A depicts a side view of the photonic integrated circuit 400, while FIG. 4B depicts a plan view of photonic integrated circuit 400.

As shown, the photonic integrated circuit 400 may comprise multiple layers. As shown in FIG. 4A, a lower layer 402 of the photonic integrated circuit 400 may comprise an array of grating couplers 404, a middle layer 406 may comprise at least one chip-scale flat optical lens 408 overlaying the array of grating couplers 404, and an upper layer 410 may comprise an ion trap 412. (The ion trap is not shown in FIG. 4B to simplify the drawing and improve clarity.) A multipoint array 414 is positioned above the upper layer 410.

The points of the multipoint array 414 may correspond to ions, neutral atoms, Rydberg atoms or other points of any array onto which light is desired to be focused. The number of points of the multipoint array 414 is not limited. In some examples, the multipoint array 414 may comprise greater than 5, 10, 15, 20, 25, 30, 40, 50, 60, 70, or 100 points.

Additionally, further layers, including spacer layers, may be included as needed or desired. The photonic integrated circuit 400 may include additional components (not shown) as desired.

As best seen in FIG. 4B, the array of grating couplers 404 may comprise a plurality of grating couplers 418 (individually, 418(1) to 418(n)). As shown by example, the grating couplers 418 in the array of grating couplers 404 may be laterally arranged on the photonic integrated circuit 400, such that the grating couplers 418 extend in a row. However, other arrangements, such as staggered arrangements, are possible.

The number of grating couplers is not limited and may be selected according to the number of points of the multi-point array to be addressed. In some examples, the grating couplers 418 may comprise greater than 5, 10, 15, 20, 25, 30, 40, 50, 60, 70, or 100 grating couplers or pairs of grating couplers.

The grating couplers 418 are preferably optically coupled to photonic waveguides (not shown) or other optical components configured to transmit a light beam 416 to the grating couplers. The grating couplers are formed by a plurality of gratings. Generally, the gratings may be configured as a series of non-intersecting linear or substantially linear projections on a surface of the substrate or chip. Suitably, the gratings of the grating couplers 418 may typically extend generally parallel to one another. In some aspects, the gratings may be straight-grating-teeth gratings such that they lack substantial curvature. In some aspects, the gratings may be curved-grating-teeth gratings or have any suitable radian to produce the desired beam dimensions. The gratings may have any suitable thickness (i.e., height), linewidth, length or pitch to produce the desired beam dimensions and/or directionality.

The number of grating couplers in the array of grating couplers may be greater than or equal to a number of points of the multi-point array to be addressed. For example, as shown in FIG. 4B, as example of the multipoint array may include nine points represented by ions and the array of grating couplers 404 is configured such that each point of the multipoint array may be addressed by a light beam.

In the example shown in FIG. 4B, the array of grating couplers comprises pairs of grating couplers, each arranged in one of two rows, for each point to be addressed. In such examples, each grating coupler 418 of the pair of grating couplers may emit a light beam 416, such that the point 414 may be addressed by two light beams 416 emitted from different directions. This configuration is particularly advantageous in quantum computing applications that utilize Raman transitions to effect qubit gate operations.

Advantageously, examples utilizing paired grating coupler may achieve a Δk_{Raman} value of the pair of light beams emitted by a pair of grating couplers that corresponds to a k-vector oriented parallel to a surface of the photonic integrated circuit. In quantum computing, and specifically in the quantum circuit model of computation, a quantum gate (or a quantum logic gate) is a building block of quantum circuits. The quantum gates operate on a small number of qubits, which are represented by unitary matrices and correspond to points of the multipoint array. The qubits (e.g., ions) may be coherently manipulated with a pair of mode-locked lasers at 355 nm whose frequency comb beat notes drive stimulated Raman transitions between the qubit states and produce qubit state-dependent forces. A wave vector difference between the lasers is Δk or Δk_{Raman}. As shown in FIG. 4B, the ΔkRaman oriented substantially parallel to the chip surface and orthogonal to the ion array linear chain axis for each laser beam pair.

One or more chip-scale flat optical lens 408 overlaying the array of grating couplers 404 may be configured to focus, or image, the light from the grating couplers onto the multipoint array 414. Flat lenses typically employ metamaterials or electromagnetic structures engineered on subwavelength scales to elicit tailored polarization responses. Suitable materials for the chip-scale flat optical lens 408 may be a metalens, a GRIN lens, a diffractive lens or the like.

Each chip-scale flat optical lens 408 may include one or more areas of optical index contrast 420. In some examples, the one or more areas of optical index contrast 420 may be positioned in alignment with the grating couplers 418 such that light beams 416 emitted from the grating couplers 418 passes through the one or more areas of optical index contrast 420 and are focused thereby.

In addition to imaging or focusing the light beams, the chip-scale flat optical lens or optical relay may be configured to change a mode of the light beams emitted from the grating couplers. For example, the chip-scale flat optical lens may alter a light beam emitted by the grating between Gaussian, a flat top beam, Hermite-Gaussian beam, or a Laguerre-Gaussian beam.

The chip-scale flat optical lens 408 overlaying the array of grating couplers 404 may be configured to focus, or image, the light from the grating couplers onto the multipoint array 414. The one or more areas of optical index contrast 420 may be configured to adjust the focal length of the chip-scale flat optical lens 408 to achieve the desired magnification.

In some examples, the magnification of the chip-scale flat optical lens 408 or optical relay may be approximately 1×, such that the beam size at each point of the multi-point array will be equal to the beam size at the grating emission point. In this configuration, the flat lens may have a focal length approximately equal to half its distance from the ion array and can also be positioned to be approximately twice its focal length away from the grating array.

However, the focal length of the chip-scale flat optical lens or optical relay may be selected to adjust the magnification of the light beams as desired to address the points of the multipoint array. The ratio of the focal length of the chip-scale flat optical lens, to the distance between the array of grating couplers and the chip-scale flat optical lens may be between 1 to 2 for magnifications greater than one. According to an exemplary aspect, the ratio of the focal length of the chip-scale flat optical lens, to the distance between the array of grating couplers and the chip-scale flat optical lens may be between 2 and infinity for magnifications less than one. In this range the lens-grating coupler distance is between 2 f and 5 f. And the lens-ion distance is between 2 f and 1.25 f. In another aspect, the distance between the array of grating couplers and the chip-scale flat optical lens may be between 1 and ¼. In this range the lens-grating coupler distance is between 2 f and 5 f. And the lens-ion distance is between 2 f and 1.25 f.

For a magnification of 1 with a single flat lens, the grating coupler may be placed at a distance from the lens, of twice the focal length of the lens (d_grating=2f), as would the ions be placed at a distance of 2f from the lens. To increase the magnification, the grating couplers may be brought closer to the lens, such as up to a distance of one focal length from the lens. In this range, the distance between the lens and the ions could span between 2f, and infinity. The opposite is true for magnifications less than 1, where the ions may be positioned at distances from the lens between f and 2f, and the grating couplers positioned between 2f and infinity away.

In an exemplary aspect, the ratio of a focal length of the chip-scale flat optical lens and a distance between the array of grating couplers and the chip-scale flat optical lens may be between 0.2 to 0.5. The ratio of a focal length of the chip-scale flat optical lens and a distance between the chip-scale flat optical lens and the points to be addressed may be 0.5-0.8. In another exemplary aspect, for a magnification of 1 with a single flat lens, the grating coupler can be placed at a distance from the lens of twice the focal length of the lens (d_grating=2f), as would the ions be placed at a distance of 2f from the lens. Moreover, in order to increase the magnification, the grating couplers can be brought closer to the lens, up-to a distance of one focal length from the lens. In this range the distance between the lens and the ions could span between 2f, and infinity. It is also noted that the opposite is true for magnifications less than 1, where the ions may be positioned at distances from the lens between f and 2f, and the grating couplers positioned between 2f and infinity away.

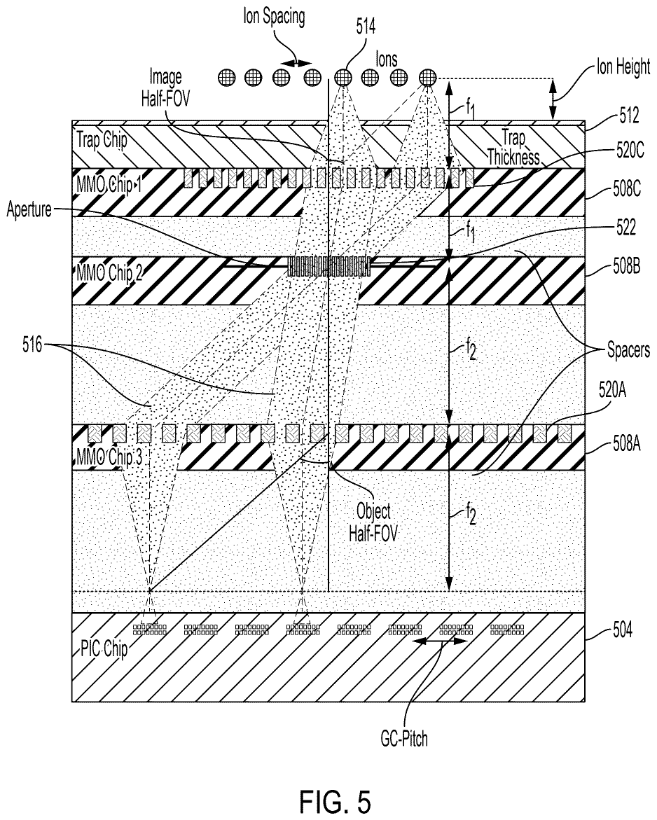

In FIG. 5, a photonic integrated circuit 500 is shown which is similar to the photonic integrated circuit 400. The photonic integrated circuit 500 comprises a lower layer including an array of grating couplers 404, a middle layer including multiple chip-scale flat optical lenses 508A, 508B, and 508C overlaying the array of grating couplers 504, and an upper layer including an ion trap 512. As shown, the chip-scale flat optical lenses 508A, 508B and 508C are separated by spacer layers. A multipoint array 514 of ions is positioned above the ion trap 512.

Notably, unlike FIG. 4A, the photonic integrated circuit 500 comprises an optical relay including multiple chip-scale flat optical lenses 508A, 508B, and 508C. Each of the chip-scale flat optical lenses may have the same or different focal lengths. In FIG. 5, the chip-scale flat optical lens 508A has a focal length f2 and the chip-scale flat optical lens 508C has a focal length f1. Additionally, chip-scale flat optical lens 508B is provided with an aperture 522. Advantageously, the chip-scale flat optical lenses 508A, 508B, and 508C may be collectively configured as a double telecentric 4f relay system which provides a total magnification of 1×.

Referring again to FIG. 4A, the photonic integrated circuit 400 may assembled with an ion trap. Aspects of this disclosure relate to an ion trap assembly comprising the photonic integrated circuit 400 and a transparent ion trap 412, wherein the points 414 of the multi-point array correspond to ions in the ion trap and the photonic integrated circuit is disposed on an underside of the ion trap. As shown in FIG. 4B, light beams emitted from the array of grating couplers 404 diverge until the beams pass through the chip-scale flat optical lens 408, which focuses the beams to address the individual ion of the multipoint array.

However, the photonic integrated circuit 400 need not be integrated with an ion trap. Instead, the photonic integrated circuit 400 may be used to deliver an array of beams to an array of ions or atoms (or collect light from an array of ions or atoms) that are confined in another location, or deliver or collect light from any array of points. Applications need not be based on ion or atom addressing or relate to quantum information processing.

The photonic integrated circuit 400 may be manufactured by any suitable technique. In some aspects, one or more of the layers of the photonic integrated circuit 400 may be configured as a separate chip that is co-packaged or hybridly integrated with a chip or chips comprising other layers. Alternatively, two or more layers of the photonic integrated circuit 400 may be monolithically integrated in a single microfabrication process by building and patterning each material layer on top of one another. A combination of monolithic and hybrid integration is also contemplated.

In addition to the elements discussed above, the photonic integrated circuit 400 may additionally be assembled with independent or global laser modulators or laser sources, either as bulk devices or additional PICs, on the inputs of waveguides that feed the grating couplers to individually or globally control ions in the array through amplitude, frequency, and/or phase modulation of the light.

Aspects of this disclosure relate to methods for controlling laser beam propagation in quantum processing. The method may include providing a photonic integrated circuit as disclosed herein and transmitting light beams through the grating couplers of the array of grating couplers such that each point of the multipoint array is addressed by a single one of the light beams.

Advantageously, quantum information processing (QIP) system including a photonic integrated circuit 401 as described herein may have a compact size compared to QIPs that utilize conventional optical systems. Additionally, in yet another advantage, the photonic integrated circuits of this disclosure can be integrated with an ion trap due to their small size at a fixed position to reduce misalignment, such as misalignment due to vibration.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general-purpose computer, a special-purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps, or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” are utilized herein to mean serving as an instance or illustration. Any aspect or design described herein as an “example” or referred to in connection with a “such as” clause is not necessarily to be construed as preferred or advantageous over other aspects or designs described herein. Rather, use of the terms “example” or “such as” is intended to present concepts in a concrete fashion. The terms “first,” “second,” “third,” and so forth, as used in the claims and description, unless otherwise clear by context, is for clarity only and doesn't necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using standard programming and/or engineering techniques. In addition, various of the aspects disclosed herein also can be implemented by means of program modules or other types of computer program instructions stored in a memory device and executed by a processor, or other combination of hardware and software, or hardware and firmware. Such program modules or computer program instructions can be loaded onto a general-purpose computer, a special-purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), blu-ray disc (BD), or similar), smart cards, and flash memory devices (e.g., card, stick, key drive, or similar).

The detailed description set forth herein in connection with the annexed figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A photonic integrated circuit for addressing a multi-point array comprising:
an array of grating couplers, and
at least one chip-scale flat optical lens overlaying the array of grating couplers;
wherein a number of grating couplers in the array of grating couplers is greater than or equal to a number of points of the multi-point array to be addressed.

2. The photonic integrated circuit of claim 1, wherein a ratio of a focal length of the at least one chip-scale flat optical lens and a distance between the array of grating couplers and the at least one chip-scale flat optical lens is 0.2 to 0.5.

3. The photonic integrated circuit of claim 1, wherein a ratio of a focal length of the at least one chip-scale flat optical lens and a distance between the at least one chip-scale flat optical lens and the points to be addressed is 0.5 to 0.8.

4. The photonic integrated circuit of claim 1, wherein the grating couplers in the array of grating couplers are linearly arranged on the photonic integrated circuit.

5. The photonic integrated circuit of claim 1, wherein the at least one chip-scale flat optical lens is selected from the group consisting of a metalens, a GRIN lens, and a diffractive lens.

6. The photonic integrated circuit of claim 1, wherein the at least one chip-scale flat optical lens is configured to change the mode of the light beams emitted from the grating couplers.

7. The photonic integrated circuit of claim 1, wherein the array of grating couplers comprises a pair of grating couplers for each point to be addressed.

8. The photonic integrated circuit of claim 6, wherein a Δk_{Raman} value of a pair of light beams emitted by each pair of grating couplers corresponds to a k-vector oriented parallel to a surface of the photonic integrated circuit.

9. The photonic integrated circuit of claim 1, wherein the at least one chip-scale flat optical lens is configured as an element of an optical relay comprising multiple chip-scale flat optical lenses.

10. An ion trap assembly comprising:
the photonic integrated circuit of claim 1; and
a transparent ion trap,
wherein the points of the multi-point array correspond to ions in the ion trap and the photonic integrated circuit is disposed on an underside of the ion trap.

11. A method for controlling laser beam propagation in quantum processing, comprising:
providing a photonic integrated circuit for addressing a multi-point array comprising an array of grating couplers, and one or more chip-scale flat optical lenses overlaying the array of grating couplers; and
transmitting light beams through the grating couplers of the array of grating couplers such that each point of the multipoint array is addressed by a single one of the light beams;
wherein a number of grating couplers in the array of grating couplers is greater than or equal to a number of points of the multi-point array to be addressed, and a lateral width of each grating coupler of the array of grating couplers is less than a lateral interpoint spacing of the points to be addressed.

12. The method of claim 11, wherein a ratio of a focal length of the one or more chip-scale flat optical lenses and a distance between the array of grating couplers and the one or more chip-scale flat optical lenses is 0.2 to 0.5.

13. The method of claim 11, wherein a ratio of a focal length of the one or more chip-scale flat optical lenses and a distance between the one or more chip-scale flat optical lenses and the points to be addressed is 0.5 to 0.8.

14. The method of claim 11, wherein the array of grating couplers is linearly arranged.

15. The method of claim 11, wherein the chip-scale flat optical lens is selected from the group consisting of a metalens, a GRIN lens, and a diffractive lens.

16. The method of claim 11, further comprising changing, by the one or more chip-scale flat optical lenses, a mode of the light beams emitted from the array of grating couplers.

17. The method of claim 11, wherein the array of grating couplers comprises a pair of grating couplers for each point to be addressed.

18. The method of claim 17, wherein a Δk_{Raman} value of a pair of light beams emitted by each pair of grating couplers corresponds to a k-vector oriented parallel to a surface or the photonic integrated circuit.

19. The method of claim 11, wherein the photonic integrated circuit is disposed on an underside of a transparent ion trap and the points of the multi-point array correspond to ions in the ion trap.

20. The photonic integrated circuit of claim 11, wherein the one or more chip-scale flat optical lenses is configured as an element of an optical relay comprising multiple chip-scale flat optical lenses.
